(19) United States
(12) Patent Application Publication
(10) Pub. No.: US 2016/0003298 A1
(43) Pub. Date: Jan. 7, 2016

(54) CAGE PORTION AND METHOD FOR THE PRODUCTION THEREOF

(71) Applicant: SCHAEFFLER TECHNOLOGIES AG & CO. KG, Herzogenaurach (DE)

(72) Inventors: Horst Masuch, Schweinfurt (DE); Hermann Geyer, Vestenbergsgreuth (DE); Michael Bernutz, Nurnberg (DE)

(73) Assignee: SCHAEFFLER TECHNOLOGIES AG & CO. KG, Herzogenaurach (DE)

(21) Appl. No.: 14/770,278

(22) PCT Filed: Feb. 3, 2014
(86) PCT No.: PCT/DE2014/200038

§ 371 Date: Aug. 25, 2015

(30) Foreign Application Priority Data
Mar. 5, 2013 (DE) 10 2013 203 674.4

(51) Int. Cl. F16C 33/50; F16C 33/54

(52) U.S. Cl. CPC F16C 33/50; F16C 33/548

(57) ABSTRACT

A cage section (36), particularly for a meander-shaped cage (12) of a rolling contact bearing (14, 15), including at least one cage part (10, 11, 11′) made of a Z-shaped bent sheet-metal strip (16, 17) with a first arm (20), a connecting part (18) and a second arm (22), wherein the first arm (20) and the second arm (22) are bent substantially perpendicularly to the sheet metal plane (23). The invention further relates to a method for producing a cage portion (36), particularly for a meander-shaped cage (12) of a rolling contact bearing (14, 15).

### FIELD OF THE INVENTION

The invention relates to a cage section for, in particular, a meander-shaped cage of a rolling contact bearing, as well as a method for the production of such a cage section. In particular, the cage section is suitable for the construction of a segmented cage of a roller bearing.

### BACKGROUND

Typically, rolling bodies of a large rolling contact bearing are held and guided in a cage, in order to prevent, for example, clamping of the rolling bodies due to mutual support. Typically, e.g., the rollers of a large roller bearing with cylindrical bearing roller or tapered bearing roller construction have a cage-guided construction.

From DE 424 712 A, a cage for a rolling contact bearing is known that encloses and individually guides the rollers of the rolling contact bearing. The cage is made from solid material through material-cutting processes, wherein the production of the cage is complicated and the material expense is high. A disadvantageous result is high production costs.

An integral cage consisting of two completely identical halves that are welded together for a roller bearing is known from DE 433 223 A. The halves are produced from a sheet-metal part through shaping. A disadvantage in this type of production is that, with increasing size of the cage, the integral sheet-metal shaping becomes more and more expensive. The costs for the required tools increase, wherein simultaneously the production batch sizes decrease. In addition, there are many sheet metal cutting processes. Because two cage connecting parts lie between two adjacent rollers, the number of rollers that can be used is limited, which limits the load rating of the roller bearing.

In addition, from DE 585 099 A, a segmented cage for a roller bearing is known. The cage is assembled from several cage segments that are produced from a metal sheet and are held together with additional covers. For connecting the cage segments, complicated edge projections or tabs are required. In addition, two edge plates are required. The production costs of such a cage are high.

### SUMMARY

In recognition of these conditions, the invention is based on the objective of providing a cage section for, in particular, a meander-shaped cage of a rolling contact bearing and a method for its production. Here, the starting material should be used as optimally as possible and should make possible a simple, economical production.

The objective mentioned first with regard to a cage section is achieved according to the invention by a cage section for, in particular, a meander-shaped cage of a rolling contact bearing, comprising at least one cage part made from a Z-shaped, bent sheet-metal strip with a first arm, a connecting part, and a second arm, wherein the first arm and the second arm are bent essentially at a right angle to the plane of the sheet metal.

The cage section comprises at least one Z-shaped, bent cage part that is made from a flat metal sheet in a simple way. The cage part has, on one connecting part, a first arm that is angled essentially at a right angle to the sheet metal plane. On the connecting part there is a second arm oriented essentially perpendicular to the sheet metal plane. Cage sections or complete, in particular, meander-shaped cages can be produced from a plurality of such cage parts in a Z-shape through the series arrangement of the arms in a simple way. Through two at least partially overlapping arms and two connecting parts of adjacent cage parts, a cage pocket for a corresponding rolling body is formed. The cage parts do not have to have identical constructions. In particular, through two cage parts that are different from each other, e.g., with differently shaped arms, a meander-shaped cage could be provided. The arms of a cage part could also differ from each other, e.g., in width or length.

The objective mentioned second with regard to a method is achieved according to the invention by a method for the production of a cage section for, in particular, a meander-shaped cage of a rolling contact bearing, wherein a sheet-metal strip is cut from a metal sheet and wherein the sheet-metal strip is shaped into a Z-shape with a first arm, a connecting part, and a second arm, so that the first arm and the second arm are angled essentially at a right angle to the sheet metal plane.

Accordingly, at first a flat strip is cut out from a metal sheet. The cut-out strip is shaped into a Z-shaped cage part with a first arm, a connecting part, and a second arm, and the two arms are bent away from the connecting part essentially perpendicular to the sheet metal plane. A cage section comprises at least one Z-shaped cage part. A cage section, however, can also comprise several of the cage parts. Adjacent cage parts are placed one above the other with their arms. Several cage parts can be assembled to form a complete, in particular, meander-shaped cage.

The specified cage section or the specified cage part can be produced from a metal sheet with the help of simple tools and with minimal cutting. The sheet metal strip is, in particular, punched out and bent into a Z-shaped cage part. From the cage parts or from the cage sections comprising a number of such cage parts, a cage for large roller bearings can be easily assembled. For this purpose, two Z-shaped cage parts are placed one above the other with their arms and, in particular, connected rigidly to each other. For example, the arms of adjacent cage parts can be connected to each other by welding, soldering, swaging, beading, bonding, and/or clinching.

Preferably, a cage section comprises at least two of the previously described cage parts that are assembled into a U-shaped overlapping at their arms. Such a cage section forms, to some extent, a cage pocket in which a rolling body is held and guided. The two cage parts are advantageously connected to each other in an angled arrangement at the overlapping arms. In particular, the previously mentioned joining methods are suitable for connecting the arms. The curvature and thus the size of the complete, ring-shaped cage are defined by the angle between the overlapping arms of the two cage parts of a U-shaped cage section. The angle is greater than 90° and less than 180°.

Advantageously, a plurality of U-shaped assembled from two cage parts is set one on the other with the same orientation to form a larger cage section or a complete cage, wherein the free arms of each U-shape are alternately arranged on and under a free arm of the adjacent U-shapes. Accordingly, the individual U-shaped cage sections are arranged in a fixed pattern relative to each other. In a series arrangement of the U-shaped cage sections, the two free arms are alternately placed on and under the adjacent arm of the surrounding U-shaped cage sections. This produces overall a mechanically very stable joint. The individual U-shaped cage sections are prevented from falling out by the alternating support of the arms. In particular, tilting of the U-shapes or the individual cage parts is prevented when the rolling bodies are held in the cage.

In one preferred construction, at least one arm of the Z-shaped cage part is expanded with a rounded section. Such a rounded section expanding the arm in its width is used for optimizing the guiding of the cage in the rolling contact bearing, in particular, for a rim or raceway guidance on an inner ring and/or on an outer ring of the rolling contact bearing. The axial position of the cage part or the cage in the rolling contact bearing is defined by the radius of the rounded section. In particular, both arms of a cage part can be expanded with different size rounded sections. One arm is here guided, for example, on an inner ring and one arm on the outer ring of the rolling contact bearing. The guidance of the cage by means of the arms of the cage parts can be performed, in particular, outside of the raceway of the rolling bodies, which reduces the wear on the raceway.

In one advantageous refinement, a number of raised contours are formed at least in one of the arms of the cage part or each cage part. The raised contours can be point-shaped, round, or angular and can be formed, for example, by embossing or swaging. Through the raised contours, for the guidance of the rolling bodies, the friction is reduced, because the rolling body contacts the cage or the cage part only on these contours. The contact surface of a rolling body produced by the raised contours with the cage part is smaller by a multiple than a contact surface with direct contact on the arm of the cage part. In the present case, a roller-shaped or barrel-shaped rolling body is guided in the cage formed from the cage parts by means of its end face on an arm of the cage part.

In a further preferred way, a number of raised, in particular, alternating contours is formed in the connecting part of the cage part or each cage part. In the finished cage, a roller-shaped or barrel-shaped rolling body is supported on these contours with its lateral surface. Through alternating contours, two successive rolling bodies are guided on one connecting part. Two rolling bodies are spaced apart from each other and guided by the connecting part of a cage part.

In one preferred alternative, a tab is formed on at least one of the arms of the cage part or each cage part at the end, which encloses an acute angle with its longitudinal axis with respect to the unshaped flat sheet metal strip. For the assembly of two adjacent cage parts, the angle of the overlapping arms is set relative each other by means of the angle of the tab to the longitudinal axis. Here, the tab of an arm of the cage part is supported on the connecting part of the other cage part. A complicated tool is not required to maintain the angle specified for forming the ring-shaped cage during the assembly of the individual cage parts. The length of the tab defines the distance of the Z-shaped cage parts to be connected to each other. In other words, the tab represents an assembly aid for orienting two adjacent cage parts. In addition, the tab stabilizes a joint built from a plurality of cage parts. Through the stop of the tab on the connecting part of the adjacent cage part, in the finished cage, operating play is generated for the rolling bodies in the circumferential direction, so that jamming of rolling bodies supported one on the other is reliably prevented.

Advantageously, a recess is formed in the transition between an arm and the connecting part of a cage part or each cage part. The previously mentioned tab engages in such a recess for the assembly of the cage, which further mechanically stabilizes the shown joint made from cage parts.

In one advantageous refinement, several of the previously described U-shaped cage sections are assembled into a cage or connected rigidly to each other to form an integral cage. In particular, two different cage parts are connected to each other. The U-shaped cage sections are here arranged in a fixed pattern relative to each other. In particular, for the series arrangement of the U-shaped cage sections, the two free arms are alternatively placed on and under the adjacent arm of the surrounding U-shaped cage sections. This produces overall a mechanically very stable joint. The individual U-shaped cage sections are prevented from falling out in the axial direction by the alternating support of the arms.

Another aspect of the invention is, in particular, a meander-shaped rolling contact bearing, in particular, a roller bearing, with an outer ring, an inner ring, and several rolling bodies guided in a cage, wherein the cage is assembled from several of the previously mentioned cage sections.

### BRIEF DESCRIPTION OF THE DRAWINGS

Embodiments of the invention will be explained in more detail with reference to a drawing and with reference to the following description. Shown in schematic representation are:

FIG. 1 a flat sheet-metal strip for a Z-shaped, bent cage part in a first embodiment,

FIG. 2 the Z-shaped, bent cage part according to the first embodiment,

FIG. 3 a flat sheet-metal strip for a Z-shaped, bent cage part in a second embodiment,

FIG. 4 the Z-shaped, bent cage part according to the second embodiment,

FIG. 5 a U-shaped cage section assembled from two Z-shaped, bent cage parts,

FIG. 6 a plurality of assembled U-shaped cage sections,

FIG. 7 a cage assembled from a plurality of U-shaped cage sections,

FIG. 8 a roller bearing in two cross-sectional views, and

FIG. 9 a part of a roller bearing in a side view.

### DETAILED DESCRIPTION OF THE PREFERRED EMBODIMENTS

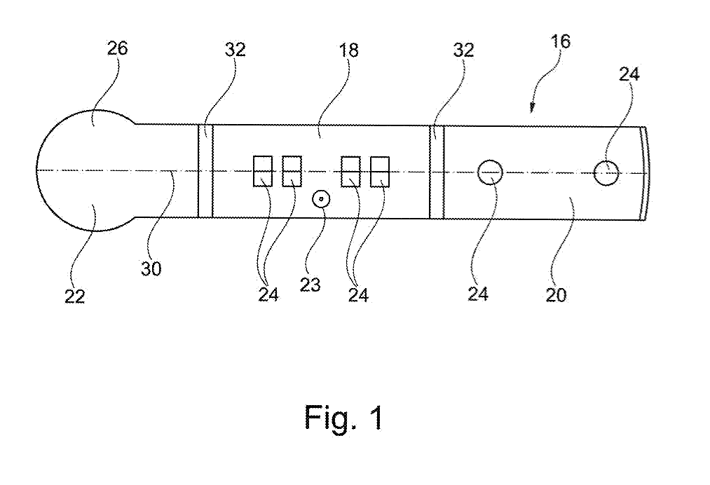

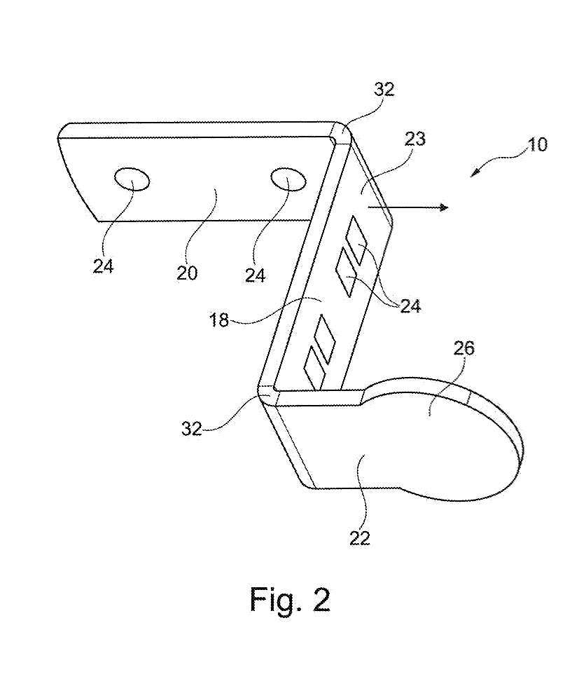

FIG. 1 shows a cutout flat sheet metal strip 16 for the production of a cage part 10 (see FIG. 2) according to a first embodiment. The flat sheet metal strip 16 comprises a first arm 20, a connecting part 18, and a second arm 22. On both sides of the connecting part 18 there is a transition area 32 to the two arms 20, 22. The longitudinal axis 30 of the flat sheet metal strip 16 is indicated with a dashed line. For the sheet metal plane 23, the surface normals are shown. The second arm 22 ends in a rounded section 26 that projects over the connecting part 18 or the arm 22 in the respective width. The connecting part 18 further has a number of stamped, raised contours 24 with an approximately angular cross-sectional surface. The contours 24 are formed alternating. Along the longitudinal axis 30 of the connecting part 18, they extend alternately out of the plane of the drawing toward the viewer and into the plane of the drawing away from the viewer. The first arm 20 has the width of the connecting part 18. Raised contours 24 with an approximately circular cross section are formed in the first arm 20. The round and angular raised contours 24 form, in the finished cage part 10, the respective contact surfaces for a rolling body 42.

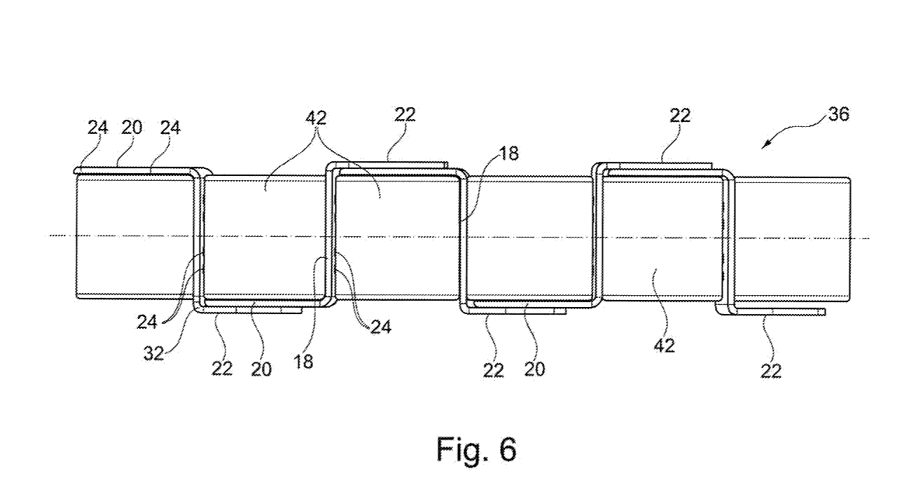

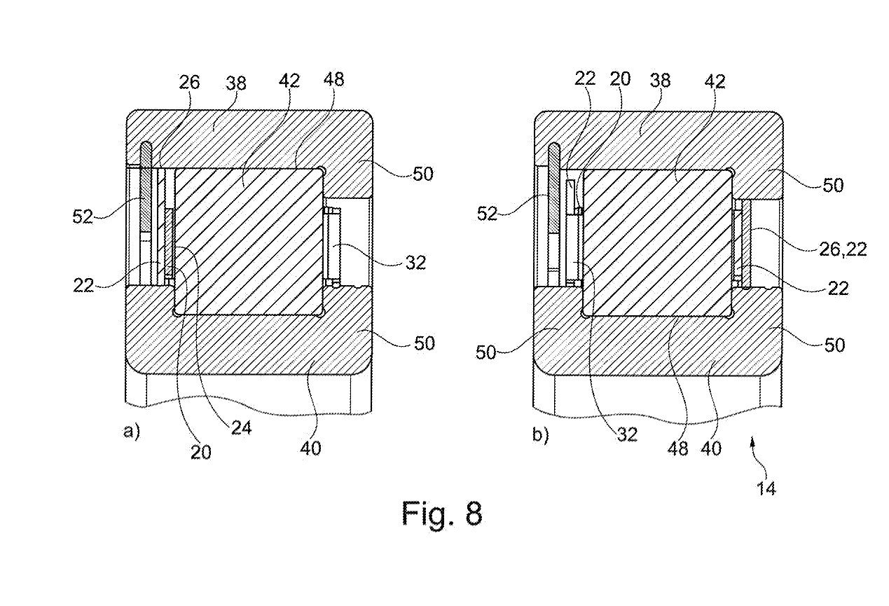

In FIG. 2, the cage part 10 shaped from the sheet metal strip 16 of FIG. 1 into a Z-like shape can be seen. The two arms 20, 22 are lifted from the connecting part 18 in opposite directions essentially perpendicular to the sheet metal plane 23. The rounded section 26 of the second arm 22 represents, in a cage assembled from the cage parts 10 (see, e.g., FIGS. 6, 8), in particular, a guide on a rim of an inner ring or outer ring of a rolling contact bearing. A roller in the cage as a rolling body is supported with its lateral surface on the connecting part 18 and with its end face on the first arm 20 or on the contours 24. The second arm 22 is formed for fastening onto an overlapping first arm 20 of an adjacent cage part 10. The operating play can be specified in the circumferential direction for a rolling body by means of the length of the first arm 20. In the finished cage, for example, the first arm 20 is supported on the connecting part 18 of the adjacent cage part 10. Therefore, in particular, eliminated from the shown embodiments, the length of the first arm 20 is greater than the diameter of the rolling body.

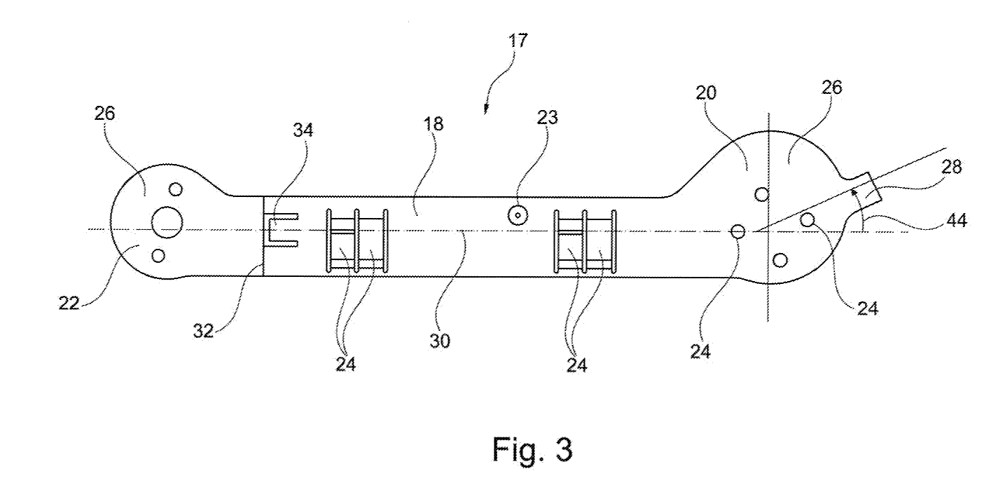

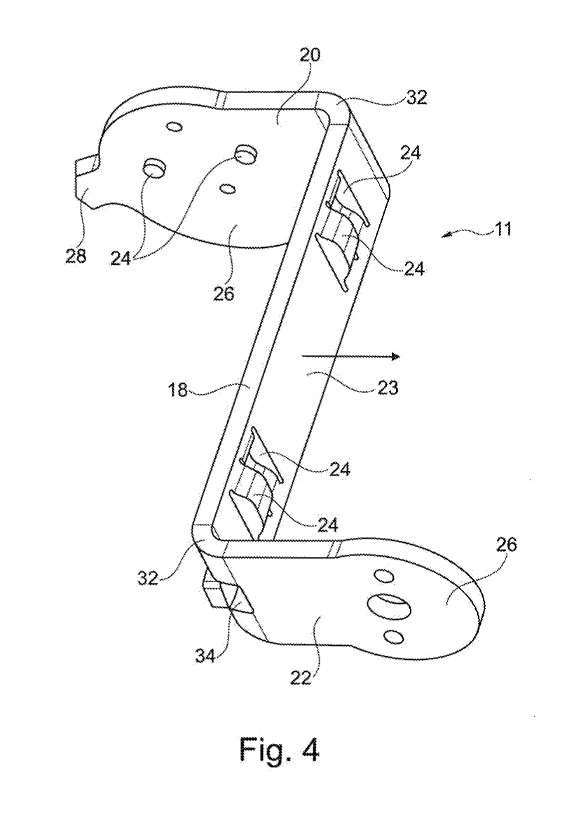

In FIG. 3, a cutout flat sheet metal strip 17 is shown for a cage part 11 according to a second embodiment (see FIG. 4). The flat sheet metal strip 17 comprises, in turn, a first arm 20, a connecting part 18, and a second arm 22. In the present case, both arms 20, 22 end in rounded sections 26 that differ in their size. A tab 28 is formed on the first arm 20, wherein this arm is at an acute angle 44 relative to the longitudinal axis 30 of the sheet metal strip 17. In the transition area 32 between the second arm 22 and the connecting part 18 there is also a recess 34. The connecting part 18 and the first arm 20 have, in turn, a number of raised contours 24 for guiding a rolling body.

FIG. 4 shows the Z-shaped cage part 10 produced by shaping the sheet metal strip 17 according to FIG. 3 according to the second embodiment with arms 20, 22 bent essentially perpendicular to the sheet metal plane 23. The connecting part 18 has raised contours 24 alternately on both sides with an essentially angular basic shape, with these contours being formed by pressing. Also on the first arm 20, raised contours 24 for guiding a rolling body are visible. The contours 24 of the first arm 20 extend downward in the drawing. Both arms 20, 22 are used for guiding the corresponding end sides of rollers that are used as rolling bodies and are spaced apart from each other by the connecting part 18 of the cage part 11. On the first arm 20, the rolling body is guided directly by means of the raised contours 24. A corresponding second arm 22 of an adjacent cage part with contours 24 is placed on the second arm 22, on which then, in turn, the corresponding rolling body is supported directly. The recess 34 is visible on the transition area 32 between the second arm 22 and the connecting part 18.

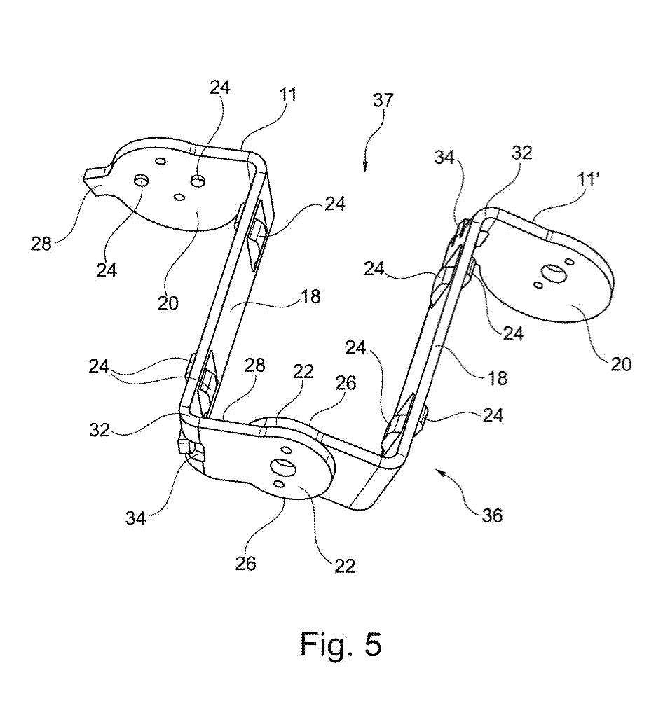

In FIG. 5, a U-shaped cage section 36 assembled from two Z-shaped, bent cage parts 11, 11′ is shown. The cage part 11 shown on the left in FIG. 5 corresponds to the cage part 11 according to FIG. 4. The cage part 11′ shown on the right in the drawing is modified compared with the construction of the arms 20, 22. For example, the first arm 20 of the right cage part 11′ has no raised contours 24 for guiding a rolling body. Also, on the first arm 20 of the second cage part 11′, a corresponding tab 28 is missing. However, a tab 28 that is not visible in FIG. 5 is formed, instead, on the second arm 22 of the right cage part 11′.

Between the cage parts 11, 11′, a produced cage pocket 37 for holding a roller or cylindrical rolling body can be seen. The rolling body located therein is guided with its lateral surface on the contours 24 of the connecting parts 18 projecting into the cage pocket 37 and with its lower end face on the contours 24 of the second arm 22 of the right cage part 11′.

The second or right cage part 11′ is placed in an angled arrangement with its modified second arm 22 on the second arm 22 of the first or left cage part 11. The cage parts 11, 11′ are connected rigidly to each other at the arms 20, 22. The connection can be realized, for example, through welding, soldering, swaging, beading, bonding, or clinching. Here, each rounded section 26 of the second arms 22 of the left cage part 11 and the right cage part 11′ overlap each other. The tab 28 set on the rounded section 26 of the second arm 22 of the right cage part 11′ is supported in the recess 34 formed at the transition 32 between the second arm 22 and the connecting part 18 of the left cage part 11. Through the engagement of the tab 28 in the recess 34, on one hand the assembly of the two cage parts 11, 11′ is simplified and on the other hand a higher stability of the U-shaped cage section 36 is achieved. In addition, operating play is set in this way for the rolling bodies in the circumferential direction, so that jamming of adjacent rolling bodies is prevented.

The two arms 20, 22 of successive cage parts 11, 11′ are connected to each other so that they enclose an obtuse angle relative to each other. The angle is produced during assembly by the interaction of the tabs 28 and recesses 34. The size of the complete rolling contact bearing is given by the size of the angle at which the U-shaped cage sections 36 are joined to each other.

The U-shaped cage section 36 shown in FIG. 5 and assembled from cage parts 11, 11′ could also be formed from cage parts 10, as shown in FIGS. 1 and 2.

In FIG. 6, a larger cage section 36 formed from a plurality of cage parts 10 corresponding to FIG. 2 is shown with roller-shaped rolling bodies 42. Every two cage parts 10 are joined to each other with alternating orientation. The U-shaped cage section produced from every two adjacent cage parts 10 are joined together in the same orientation. The first arm 20 of a cage part 10 is always oriented with its contours 24 inward relative to the end side of each rolling body 42. A second arm 22 contacts a first arm 20 on the outside. With this joining pattern, a complete, meander-shaped cage is produced overall. After setting the rolling bodies 42 in the cage 12, the U-shaped cage sections are self-supporting.

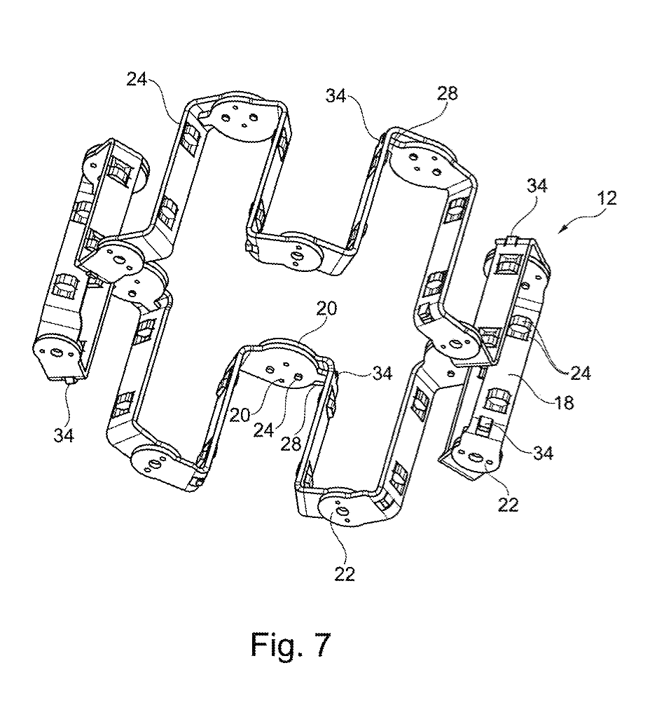

In FIG. 7, a complete, meander-shaped cage 12 is shown, like that produced by an identically oriented, series arrangement of U-shaped cage sections 36 from FIG. 5.

In FIG. 8, in two cross sections a) and b), a rolling contact bearing 14 formed as a roller bearing is shown with a cage made from two different, alternating cage parts 10 according to FIG. 2 set one on the other. Adjacent cage parts 10 differ here in the size of each rounded section 26 formed on the second arm 22. Cross section a) and cross section b) run in the rolling contact bearing 12 through successive, adjacent rolling bodies 42. FIG. 8 shows, between an outer ring 38 and an inner ring 40, a rolling body 42. This rolls with its lateral surface 48 on a raceway of an outer ring 38 and an inner ring 40. For guiding the rolling bodies 42, both the inner ring 40 and also the outer ring 38 each have at least one rim 50.

In the shown cross section a), the rolling body 42 on the left is guided on the first arm 20 of a cage part. A second arm 22 of an adjacent cage part contacts the first arm 20. By means of the rounded section 26 of the second arm, every second cage part on the left of the rolling body 42 is guided with little play between the outer ring 38 and the inner ring 40 of the rolling contact bearing 14 outside of the raceway. On the right side of the rolling body 42 there is a view of the transition area 32 of the next cage part.

In the shown cross section b), the rolling body 42 on the right is guided on the first arm 20 of a cage part. A second arm 22 of an adjacent cage part contacts the first arm 20. The rounded section 26 visible in cross section b) belongs to another cage part than the rounded section 26 in cross section a). The rounded sections 26 differ in size. By means of the rounded section 26 of the second arm, every second cage part on the right of the rolling body 42 is guided with little play between the outer ring 38 and the inner ring 40 of the rolling contact bearing outside of the raceway. On the left side of the rolling body 42 there is a view of the transition area 32 of the next cage part.

A sealing ring 52 is also inserted in the drawing on the left between the outer ring 38 and the inner ring 40 of the shown rolling contact bearing 12.

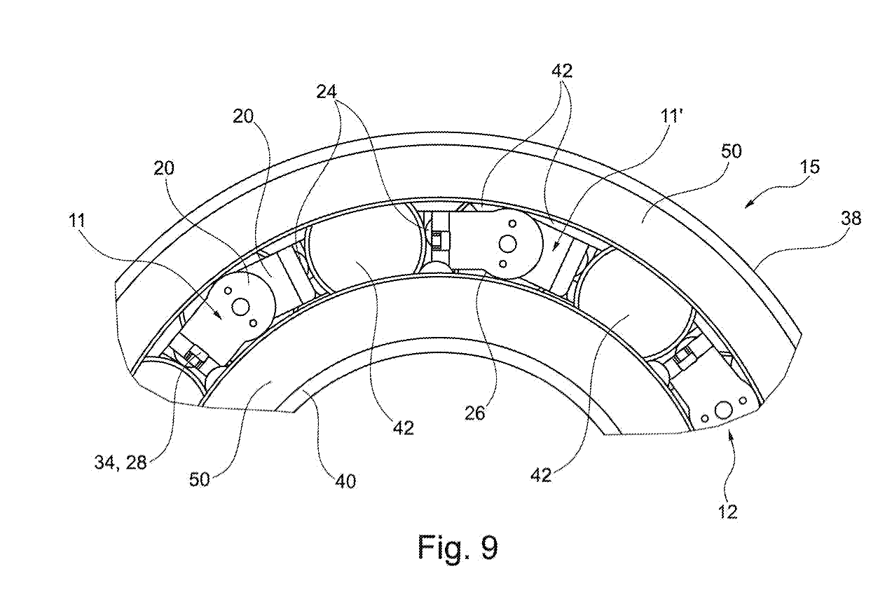

FIG. 9 shows a lateral view of a part of another rolling contact bearing 15 formed as a roller bearing. The rolling contact bearing 15 has an outer ring 38 and an inner ring 40 each with a rim 50. For guiding the rolling body 42, a cage 12 according to FIG. 7 is used. Visible are the overlapping first arms 20 of the corresponding cage parts 11, 11′ joined to each other at an angle. Through the width of the rounded sections 26 of each first arm 20, the distance of the respective cage part 11 to the outer ring 38 and inner ring 40 is set. The cage 12 is guided by the rims in the rolling contact bearing 14. On the first arm 20 of a cage part 11, the recess 34 is also visible in which the tab 28 of a second cage part 11′ engages. The rolling bodies 42 are each guided between two raised contours 24 of two connecting parts 18 of adjacent cage parts 11, 11′.

### LIST OF REFERENCE NUMBERS

10 Cage part
11Cage part
11′ Cage part
12 Cage
14 Rolling contact bearing
15 Rolling contact bearing
16 Sheet-metal strip
17 Sheet-metal strip
18 Connecting part
20 First arm
22 Second arm
23 Sheet-metal plane
24 Raised contour
26 Rounded section
28 Tab
30 Longitudinal axis of the sheet-metal strip
32 Transition area
34 Recess
36 Cage section
37 Cage pocket
38 Outer ring
40 Inner ring
42 Rolling body
44 Acute angle
48 Lateral surface
50 Rim
52 Sealing ring

1. A cage section for a meander-shaped cage of a rolling contact bearing, comprising at least one cage part made from a Z-shaped, bent sheet-metal strip with a first arm, a connecting part, and a second arm, the first arm and the second arm are bent essentially at a right angle to the sheet metal plane.

2. The cage section according to claim 1, comprising at least two of the cage parts that are assembled overlapping to form a U-shape at the arms, with the arms being connected to each other in an angled arrangement.

3. The cage section according to claim 2, wherein a plurality of the U-shapes each assembled from two of the cage parts are set one on the other in a same orientation and the arms are respectively arranged in an alternating U-shape arrangement, on and under the arms of adjacent ones of the U-shapes.

4. The cage section according to claim 1, wherein at least one of the arms of the cage part is expanded by a rounded section.

5. The cage section according to claim 1, wherein a plurality of raised contours are formed in the connecting part of the cage part.

6. The cage section according to claim 1, wherein a tab is attached at an end on at least one of the arms of the cage part, and said tab encloses an acute angle in the flat sheet-metal strip with a longitudinal axis thereof.

7. The cage section according to claim 1, further comprising a recess formed in a transition between an arm and the connecting part of the cage part.

8. A method for the production of a cage section for a meander-shaped cage of a rolling contact bearing, comprising cutting a sheet-metal strip from a metal sheet, and forming the sheet-metal strip in a Z-form with a first arm, a connecting part, and a second arm, so that the first arm and the second arm are angled essentially at a right angle to a sheet metal plane.

9. The method according to claim 8, further comprising assembling two of the Z-shaped, produced cage parts with the arms overlapping to form a U-shape.

10. The method according to claim 9, further comprising assembling a plurality of the Z-shaped, produced cage parts to form a circulating cage, with overlapping of the respective arms in a meander shape.
